(19) United States
(12) Patent Application Publication
(10) Pub. No.: US 2018/0213198 A1
(43) Pub. Date: Jul. 26, 2018

(54) DISPLAY PROCESSING METHOD, DISPLAY PROCESSING DEVICE AND DISPLAY DEVICE

(71) Applicant: BOE TECHNOLOGY GROUP CO., LTD., Beijing (CN)

(72) Inventors: Hui LI, Beijing (CN); Ruisi CHEN, Beijing (CN)

(73) Assignee: BOE TECHNOLOGY GROUP CO., LTD., Beijing (CN)

(21) Appl. No.: 15/329,905

(22) PCT Filed: Jun. 17, 2016
(86) PCT No.: PCT/CN2016/086204

§ 371 Date: Jan. 27, 2017

(30) Foreign Application Priority Data
Oct. 16, 2015 (CN) 201510674336.0

(51) Int. Cl. H04N 9/73; G09G 5/02

(52) U.S. Cl. CPC H04N 9/73; G09G 2320/0666; G09G 5/02

(57) ABSTRACT

A display processing method, a display processing device, and a display device are provided. The method includes acquiring a pixel signal, converting the pixel signal into a driving electrical signal base on a Gamma curve configured to compensate a corresponding color vision defect, outputting the driving electrical signal to a display panel, and displaying, by the display panel, an image based on the driving electrical signal.

### CROSS-REFERENCE TO RELATED APPLICATIONS

This application is the U.S. national phase of PCT Application No. PCT/CN2016/086204 filed on Jun. 17, 2016, which claims priority to Chinese Patent Application No. 201510674336.0 filed on Oct. 16, 2015, the disclosures of which are incorporated in their entirety by reference herein.

### TECHNICAL FIELD

The present disclosure relates to the field of display technology, and in particular to a display processing method, a display processing device and a display device.

### BACKGROUND

Color blindness is a common disease of visual abnormity or ablepsia, which is usually genetic and appears as a disability of cognizing certain colors or identifying certain colors. According to the statistics, male color blindness accounts for about 8% of the total male population, female color blindness accounts for about 0.5% of the total female population. Due to the disability of color identification, color blindness brings a lot of inconvenience to the patient's work and life. Human retina has three kinds of cone cells, namely L-cone cells sensitive to long wavelength (535-575 nm), M-cone cells sensitive to medium wavelength (500-550 nm) and S-cone cells sensitive to short wavelength (400-450 nm), respectively. Color blindness is due to the absence or variation of retinal cone cells. For example, the absence of L-cone cells corresponds to red dichromatic blindness, the absence of M-cone cells corresponds to green dichromatic blindness, and the absence of S-cone cells corresponds to blue dichromatic blindness. Red and green dichromatic blindness means being unable to distinguish between red and green, and blue dichromatic blindness means being unable to distinguish between blue and green.

In the related art, the display device is usually provided with a powerful Graphics Processing Unit (GPU), which adjusts colors by means of software so as to enable the color vision defect patient to identify color. However, the solution in the related art relies on a dedicated GPUs, so the cost is high.

### SUMMARY

The present disclosure provides a display processing method, a display processing device, and a display device, so as to reduce the cost.

To achieve the above object, the present disclosure provides a display processing method including: acquiring a pixel signal; converting the pixel signal into a driving electrical signal based on a Gamma curve configured to compensate for a corresponding color vision defect; and outputting the driving electrical signal to a display panel and displaying, by the display panel, an image based on the driving electrical signal.

Optionally, the acquiring a pixel signal further includes selecting the Gamma curve from a plurality of pre-stored Gamma curves, where each of the pre-stored Gamma curves corresponds to one color vision defect.

Optionally, prior to the selecting the Gamma curve from a plurality of pre-stored Gamma curves, the method further includes: establishing Gamma curves corresponding to different color vision defects; and storing the Gamma curves corresponding to the different color vision defects.

Optionally, the color vision defects include varying degrees of color blindness or varying degrees of color weakness.

Optionally, the driving electrical signal is at least one of a driving voltage signal, a driving current signal and a driving power signal.

To achieve the above object, the present disclosure provides a display processing device including an acquisition module, a conversion module, and an output module. The conversion module is connected to the acquisition module and the output module. The acquisition module is configured to acquire a pixel signal. The conversion module is configured to convert the pixel signal into a driving electrical signal based on a Gamma curve configured to compensate a corresponding color vision defect. The output module is configured to output the driving electrical signal to a display panel, to display by the display panel an image based on the driving electrical signal.

Optionally, the display processing device further includes a selection module connected to the conversion module. The selection module is configured to select the Gamma curve from a plurality of pre-stored Gamma curves, wherein each of the pre-stored Gamma curves corresponds to a color vision defect.

Optionally, the display processing device further includes an establishment module and a storage module which is connected to the establishment module and the selection module. The establishment module is configured to establish Gamma curves corresponding to different color vision defects. The storage module is configured to store the Gamma curves corresponding to the different color vision defects.

Optionally, the color vision defects include varying degrees of color blindness or varying degrees of color weakness.

Optionally, the driving electrical signal is at least one of a driving voltage signal, a driving current signal and a driving power signal.

To achieve the above object, the present disclosure provides a display device including a display panel and the above-described display processing device.

According to the display processing method, the display processing device and the display device in the present disclosure, a pixel signal is converted into a driving voltage signal based on a Gamma curve for the display panel to display an image based on the driving voltage signal, and a Gamma curve is configured to compensate a corresponding color vision defect. Therefore, the color vision defect patients may be enabled to identify colors only by employing the Gamma curve configured to compensate color vision defects without the GPU with a high cost, thereby reducing the cost.

### BRIEF DESCRIPTION OF THE DRAWINGS

In order to illustrate the technical solutions of the present disclosure or the related art in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a flow chart of a display processing method provided in some embodiments of the present disclosure;

FIG. 2 is a flow chart of a display processing method provided in some embodiments of the present disclosure; and

FIG. 3 is a schematic diagram showing a display processing device in some embodiments of the present disclosure.

### DETAILED DESCRIPTION

The present disclosure will be described further hereinafter in conjunction with the drawings and embodiments. The following embodiments are for illustrative purposes only, but shall not be used to limit the scope of the present disclosure.

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

To make those skilled in the art better understand the technical solution of the present disclosure, the display processing method, the display processing device and the display device provided in the present disclosure will be described hereinafter in detail in conjunction with the drawings.

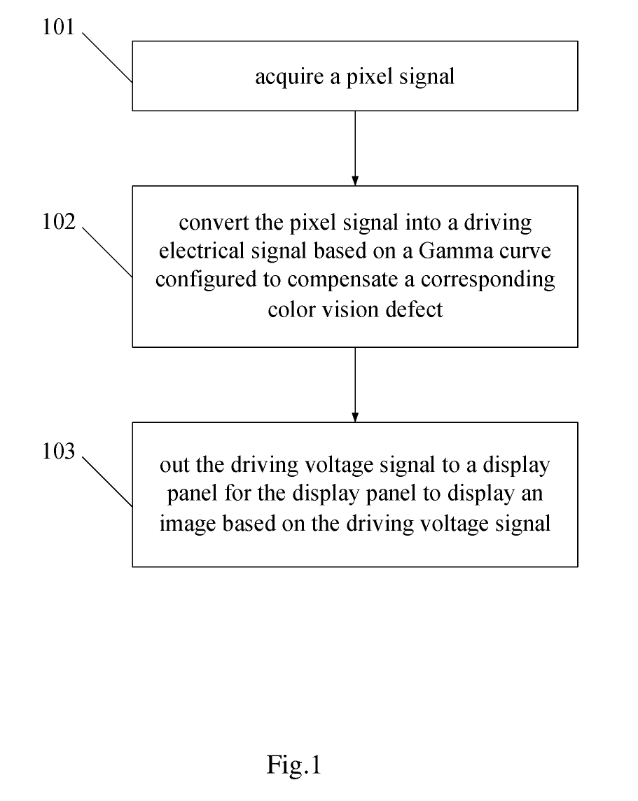

FIG. 1 is a flow chart of a display processing method in some embodiments of the present disclosure. As shown in FIG. 1, the method includes, for example, Step 101 to Step 103.

In Step 101, a pixel signal is acquired.

In Step 102, the pixel signal is converted into a driving electrical signal based on a Gamma curve configured to compensate a corresponding color vision defect.

In the display panel, there is a non-linear relationship between the luminance of the pixel and the voltage applied to the pixel, and the curve that reflects this non-linear relationship is called Gamma curve. In some embodiments, the Gamma curve is configured to compensate the color vision defect corresponding to the Gamma curve. In some embodiments, the pixel signal is required to be converted into a corresponding driving voltage signal for displaying an image based on the Gamma curve. Of course, it will be understood by those skilled in the art that the pixel signal may also be converted into a corresponding electrical signal of other forms based on the Gamma curve as needed. The electrical signal may be a driving current signal, a driving power signal and the like which are also used for displaying an image.

In Step 103, the driving voltage signal is outputted to a display panel for the display panel to display an image based on the driving voltage signal.

According to the display processing method in the present disclosure, a pixel signal is converted into a driving voltage signal based on a Gamma curve for the display panel to display an image based on the driving voltage signal. The Gamma curve is configured to compensate the corresponding color vision defect. Therefore, the color vision defect patients may be enabled to identify colors only by employing the Gamma curve configured to compensate color vision defects without the GPU with a high cost, thereby reducing the cost.

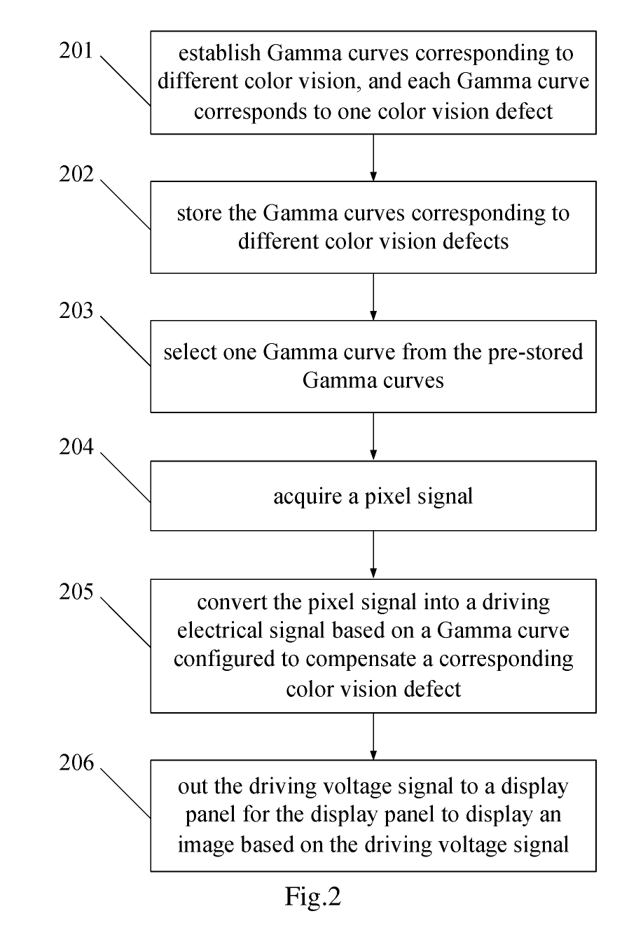

FIG. 2 is a flow chart of a display processing method provided in some embodiments of the present disclosure. As shown in FIG. 2, the method includes, for example, Step 201 to Step 206.

In Step 201, Gamma curves corresponding to different color vision defects are established, and each Gamma curve corresponds to one color vision defect.

In some embodiments, color vision defects comprise varying degrees of color blindness or varying degrees of color weakness. Among them, the color blindness may comprise red color blindness, green color blindness, or blue color blindness. Likewise, the color weakness may comprise red color weakness, green color weakness, or blue color weakness. Varying degrees of color blindness may comprise varying degrees of red color blindness, varying degrees of green color blindness or varying degrees of blue color blindness. Similarly, varying degrees of color weakness may comprise varying degrees of red color weakness, varying degrees of green color weakness or varying degrees of blue color weakness. For color blindness patients belonging to the same kind of color blindness, each person's degree of color blindness is different, so it is necessary to divide the same kind of color into varying degrees of color blindness according to the degree of color blindness. For example, for red color blindness, the red color blindness can be divided into varying degrees of color blindness.

During the execution of Step 201, the patient having the above color vision defect may be invited to cooperate to complete the establishment of a Gamma curve corresponding to a different color vision defect. Specifically, the patient having the color vision defect is positioned in front of a display device for test, the display device playing a test screen, and the Gamma curve is adjusted during playback until the patient having the color vision defect sees the test screen clearly. At this time, the Gamma curve, which is used when the patient having the color vision defect sees the test screen clearly, is determined as the Gamma curve corresponding to the color vision defect to complete the process of establishing the Gamma curve corresponding to the color vision defect. Thereafter, patients with other color vision defects continue to be invited and the process described above is repeated to complete the process of establishing Gamma curves corresponding to different color vision defects.

In the established Gamma curves, each color vision defect corresponds to one Gamma curve. In other words, the Gamma curves are in one-to-one correspondence to the color vision curves.

In Step 202, the Gamma curves corresponding to different color vision defects are stored.

In Step 203, one Gamma curve is selected from the pre-stored Gamma curves.

The patient having a color vision defect using the display device may select one Gamma curve from the pre-stored Gamma curves. During the selection of the Gamma curve, the patient having the color vision defect may switch over the pre-stored Gamma curves and observe the images displayed in the case of different Gamma curves, and the Gamma curve adopted when the displayed image can be clearly observed is selected.

In Step 204, a pixel signal is acquired.

In Step 205, the pixel signal is converted into a driving electrical signal based on the selected Gamma curve configured to compensate a corresponding color vision defect. Of course, it will be understood by those skilled in the art that the pixel signal may also be converted into a corresponding electrical signal of other forms based on the Gamma curve as needed. The electrical signal may be a driving current signal, a driving power signal and the like which are also used for displaying an image.

In Step 206, the driving voltage signal is outputted to a display panel for the display panel to display an image based on the driving voltage signal.

Since the selected Gamma curve corresponds to one color vision defect, the display panel may display based on the driving voltage signal an image where the color unidentifiable by the patient having the color vision defect is converted into an identifiable color, thereby compensating the color vision defect, so as to enable the patient having the color vision defects to identify the color.

According to the display processing method in the present disclosure, a pixel signal is converted into a driving voltage signal based on a Gamma curve for the display panel to display an image based on the driving voltage signal. The Gamma curve is configured to compensate the corresponding color vision defect. Therefore, the color vision defect patients may be enabled to identify colors only by employing the Gamma curve configured to compensate color vision defects without the GPU with a high cost, thereby reducing the cost.

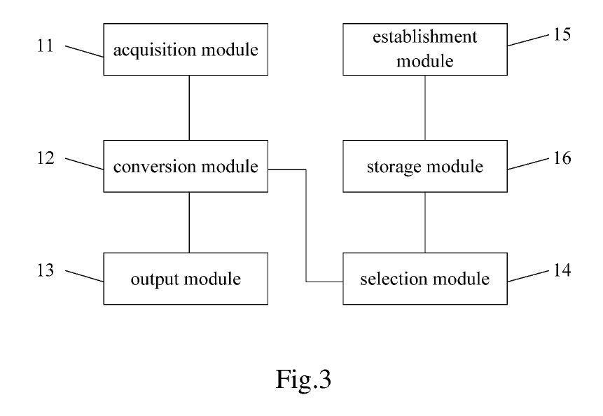

FIG. 3 is a schematic diagram showing a display processing device in some embodiments of the present disclosure. As shown in FIG. 3, the device includes an acquisition module 11, a conversion module 12 and an output module 13, and the conversion module 12 is connected to the acquisition module 11 and the output module 13.

The acquisition module 11 is configured to acquire the pixel signal. The conversion module 12 is configured to convert the pixel signal into a driving electrical signal based on a Gamma curve configured to compensate a corresponding color vision defect. The output module 13 is configured to output the driving electrical signal to a display panel for the display panel to display an image based on the driving electrical signal. Of course, it will be understood by those skilled in the art that the pixel signal may also be converted into a corresponding electrical signal of other forms based on the Gamma curve as needed. The electrical signal may be a driving current signal, a driving power signal and the like which are also used for displaying an image.

Furthermore, the device further includes a selection module 14 connected to the conversion module 12. The selection module 14 is configured to select a Gamma curve from a plurality of pre-stored Gamma curves, and each of the Gamma curves corresponding to a color vision defect. In some embodiments, the patient having a color vision defect may send a selection instruction to the selection module 14 through a dial or a button, such that the selection module 14 may select a Gamma curve based on the selection instruction. When the display panel is a touch display panel, the patient having a color vision defect may send a selection instruction to the selection module 14 by a touch operation on the screen of the display panel, so that the selection module 14 may select a Gamma curve based on the selection instruction.

Furthermore, the device further includes an establishment module 15 and a storage module 16 which is connected to the establishment module 15 and the selection module 14. The establishment module 15 is configured to establish Gamma curves corresponding to different color vision defects. The storage module 16 is configured to store the Gamma curves corresponding to the different color vision defects. To be specific, the selection module 14 may select the Gamma curve from the Gamma curves pre-stored in the storage module 16.

In some embodiments, color vision defects include varying degrees of color blindness or varying degrees of color weakness.

The display processing device may realize the display processing method hereinabove, the detailed description thereof may refer to the embodiments of the display processing method hereinabove and is omitted herein.

According to the display processing device in the present disclosure, a pixel signal is converted into a driving voltage signal based on a Gamma curve for the display panel to display an image based on the driving voltage signal. The Gamma curve is configured to compensate the corresponding color vision defect. Therefore, the color vision defect patients may be enabled to identify colors only by employing the Gamma curve configured to compensate color vision defects without the GPU with a high cost, thereby reducing the cost.

A display device is further provided, including a display panel and the display processing device provided in the embodiments hereinabove, including a display panel and the display processing device provided in the embodiments hereinabove.

Here, the display device may be any product or component having a display function such as a liquid crystal panel, an electronic paper, an organic light emitting diode (OLED) panel, a liquid crystal television, a liquid crystal display, a digital photo frame, a mobile phone, a tablet computer, or the like.

According to the display device in the present disclosure, a pixel signal is converted into a driving voltage signal based on a Gamma curve for the display panel to display an image based on the driving voltage signal. The Gamma curve is configured to compensate the corresponding color vision defect. Therefore, the color vision defect patients may be enabled to identify colors only by employing the Gamma curve configured to compensate color vision defects without the GPU with a high cost, thereby reducing the cost.

It should be appreciated that, the embodiments hereinabove are for illustrative purposes only, but shall not be used to limit the scope of the present disclosure. A person skilled in the art may make further modifications and improvements without departing from the principle of the present disclosure, and these modifications and improvements shall also fall within the scope of the present disclosure.

1. A display processing method, comprising:
acquiring a pixel signal;
converting the pixel signal into a driving electrical signal based on a Gamma curve configured to compensate for a corresponding color vision defect;
outputting the driving electrical signal to a display panel; and
displaying, by the display panel, an image based on the driving electrical signal.

2. The display processing method according to claim 1, further comprising, prior to the acquiring a pixel signal:
selecting the Gamma curve from a plurality of pre-stored Gamma curves, wherein each of the pre-stored Gamma curves corresponds to one color vision defect.

3. The display processing method according to claim 2, further comprising, prior to the selecting the Gamma curve from a plurality of pre-stored Gamma curves,
establishing Gamma curves corresponding to different color vision defects; and
storing the Gamma curves corresponding to the different color vision defects.

4. The display processing method according to claim 1, wherein the color vision defects comprise varying degrees of color blindness or varying degrees of color weakness.

5. The display processing method according to claim 1, wherein the driving electrical signal is at least one of a driving voltage signal, a driving current signal and a driving power signal.

6. A display processing device, comprising an acquisition module, a conversion module and an output module, wherein the conversion module is connected to the acquisition module and the output module;
the acquisition module is configured to acquire a pixel signal;
the conversion module is configured to convert the pixel signal into a driving electrical signal based on a Gamma curve configured to compensate a corresponding color vision defect; and
the output module is configured to output the driving electrical signal to a display panel, to display by the display panel an image based on the driving electrical signal.

7. The display processing device according to claim 6, further comprising a selection module connected to the conversion module;
wherein the selection module is configured to select the Gamma curve from a plurality of pre-stored Gamma curves, wherein each of the pre-stored Gamma curves corresponds to a color vision defect.

8. The display processing device according to claim 6, further comprising an establishment module and a storage module which is connected to the establishment module and the selection module;
wherein the establishment module is configured to establish Gamma curves corresponding to different color vision defects; and
the storage module is configured to store the Gamma curves corresponding to the different color vision defects.

9. The display processing device according to claim 6, wherein the color vision defects comprise varying degrees of color blindness or varying degrees of color weakness.

10. The display processing device according to claim 6, wherein the driving electrical signal is at least one of a driving voltage signal, a driving current signal and a driving power signal.

11. A display device, comprising:
a display panel; and
the display processing device according to claim 6.

12. The display device according to claim 11, comprising at least one of a liquid crystal panel, an electronic paper, an organic light-emitting diode (OLED) panel, a liquid crystal display television, a liquid crystal display, a digital photo frame, a mobile phone and a tablet computer.

13. The display processing device according to claim 7, further comprising an establishment module and a storage module which is connected to the establishment module and the selection module;
wherein the establishment module is configured to establish Gamma curves corresponding to different color vision defects; and
the storage module is configured to store the Gamma curves corresponding to the different color vision defects.
